(19) United States
(12) Patent Application Publication
(10) Pub. No.: US 2024/0044429 A1
(43) Pub. Date: Feb. 8, 2024

(54) Universal Anti-Leak Hose System

(71) Applicant: Crystal Health Supplies 2 LTD, Monroe, NJ (US)

(72) Inventor: Patrick Spada, Monroe, NJ (US)

(21) Appl. No.: 17/818,206

(22) Filed: Aug. 8, 2022

(51) Int. Cl. F16L 27/107

(52) U.S. Cl. CPC F16L 27/107

(57) ABSTRACT

The system and method for a universal anti-leak hose system. The anti-leak hose system being formed of an elastomeric material and having an inlet opening and on outlet opening. At least one angled section is designed to accept a portion of a gas/liquid system via at least one of the inlet opening or the outlet opening. In some cases the at least one angled section is adjacent a ridged, or threaded portion. When in use, liquid or gas exerts pressure on the hose system to further retain a portion of a gas/liquid system and mitigate leaking.

### FIELD OF THE DISCLOSURE

The present disclosure relates to liquid and gas handling systems and more particularly to a universal anti-leak system for use on hosing or tubing, or the like, in liquid and gas systems.

### BACKGROUND OF THE DISCLOSURE

Hoses, and the like, are used to convey gases and liquids (mediums) from one point to another. In some cases, these gases and/or liquids may pose a danger to humans, animals, or the environment if there is a leak. In some cases, the gas and/or liquid is at a high temperature, corrosive, toxic, flammable, or has some other characteristic that makes loss of the medium to the environment an issue. In some cases, the liquid and/or gas is expensive and any leaking from the hose, or the like, can be costly. In one very common example, if your garden hose is leaking from either of the fitting ends, you most likely have a bad gasket (or rubber washer). In some cases, you may even be missing the gasket. Over time gaskets can warp, crack or even fall out. In this example, the garden hose has male and female threaded ends that can corrode, become stripped, or even become misshapen so that they no longer mate with their counterpart (e.g., female or male ends on spigot or sprayer). This leaking over time wastes a valuable resource and can even cause damage to your home. There are countless other liquid and gas systems that utilize hoses, or tubes, or the like that have similar issues with leaking. Some systems include, but are not limited to, vehicles, industrial applications, appliances, and the like.

Wherefore it is an object of the present disclosure to overcome the above-mentioned shortcomings and drawbacks associated with the conventional techniques for handling liquid and gas systems.

### SUMMARY OF THE DISCLOSURE

It has been recognized that liquid and gas are used in a number of applications ranging from residential, industrial, medical, and many others. Any leaking in these systems often occurs at the connecting end(s) of any tubing, hosing, or the like. A universal anti-leak hose system is proposed herein that is capable of working with legacy systems and as an improved connection type on hoses of all sizes and materials to mitigate negative outcomes caused by leaking gases and/or liquids in a number of applications.

One general aspect includes a universal anti-leak hose system. The universal anti-leak hose system also includes a hollow body having a length and an outer diameter. The system also includes an outer opening at a first end of the hollow body and an outer opening at a second end of the hollow body. The system also includes at least one angled section extending inwardly into an interior of a cavity and terminating at an interior opening.

Implementations may include one or more of the following features. The system where the at least one angled section is a pair of angled sections at the first end of the hollow body and the second end of the hollow body. The hollow body is cylindrical. The hollow body has at least one portion having a reduced inner diameter located between the first end of the hollow body and the second end of the hollow body. An interior space is formed between an inner surface of the cavity and the internally threaded portion. The hollow body, the outer opening at a first end of the hollow body, the cavity, the internally threaded portion; and the at least one angled section are integrally formed of an elastomeric material. The elastomeric material is a rubber. The elastomeric material is a silicone elastomer. The system may include an externally threaded portion located at the outer opening of the second end of the hollow body.

One general aspect includes a universal anti-leak hose system. The universal anti-leak hose system also includes a hollow body. The system also includes an outer opening at a first end of the hollow body and an outer opening at a second end of the hollow body. The system also includes at least one angled section extending outwardly from the hollow body to the outer opening of the first end of the hollow body. The system also includes at least one externally threaded portion located at the outer opening of the first end of the hollow body.

Implementations may include one or more of the following features. The system where the at least one angled section is a pair of angled sections at the first end of the hollow body and the second end of the hollow body. The hollow body is cylindrical. The hollow body has a portion having a reduced inner diameter located between the first end of the hollow body and the second end of the hollow body. The hollow body, the externally threaded portion; and the at least one angled section are integrally formed of an elastomeric material. The elastomeric material is a rubber. The elastomeric material is a silicone elastomer. An interior space is formed between an inner surface of the cavity and the internally threaded portion.

One general aspect includes a universal anti-leak hose system. The universal anti-leak hose system also includes a hollow cylindrical body. The system also includes an outer opening at a first end of the hollow cylindrical body. The system also includes at least one angled section extending inwardly from the outer opening into an interior of the hollow cylindrical body and terminating at an interior opening, the interior opening having a smaller diameter than a diameter of the outer opening. The system also includes an interior space being formed between an inner surface of a sidewall of the hollow cylindrical body and the angled section. The system also includes one or more ridges located at a region may include the outer opening.

Implementations may include one or more of the following features. The system where the hollow cylindrical body has a portion having a reduced inner diameter located between the first end of the hollow cylindrical body and a second end of the hollow cylindrical body.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure. The patent or application file contains at least one drawing executed in color. Copies of this patent or patent application publication with color drawing(s) will be provided by the Office upon request and payment of the necessary fee.

FIG. 1 is a perspective diagram of one implementation of a universal anti-leak hose system according to the principles of the present disclosure.

FIG. 2 is a cross-sectional diagram showing flow of gas and/or liquid within one implementation of a universal anti-leak hose system according to the principles of the present disclosure.

FIG. 3A-FIG. 3C show an end view, a perspective view, and a cross-sectional view, respectively, of one implementation of a universal anti-leak hose system according to the principles of the present disclosure.

FIG. 4A-FIG. 4C show an end view, a perspective view, and a cross-sectional view, respectively, of one implementation of a universal anti-leak hose system according to the principles of the present disclosure.

FIG. 5A and FIG. 5B are cross-sectional diagrams of one implementation of a universal anti-leak hose system engaging with a spigot according to the principles of the present disclosure.

FIG. 6 is an enlarged perspective view of one end of another implementation of a universal anti-leak hose system according to the principles of the present disclosure.

### DETAILED DESCRIPTION OF THE DISCLOSURE

Generally, a hose is reinforced where a tube is not. Hoses are typically used for applications that involve high pressure, whereas a tube is more often used for lower pressure applications. For simplicity, however, we will use hose to indicate either a hose or a tube that is used to transport liquid or gas from one point to another.

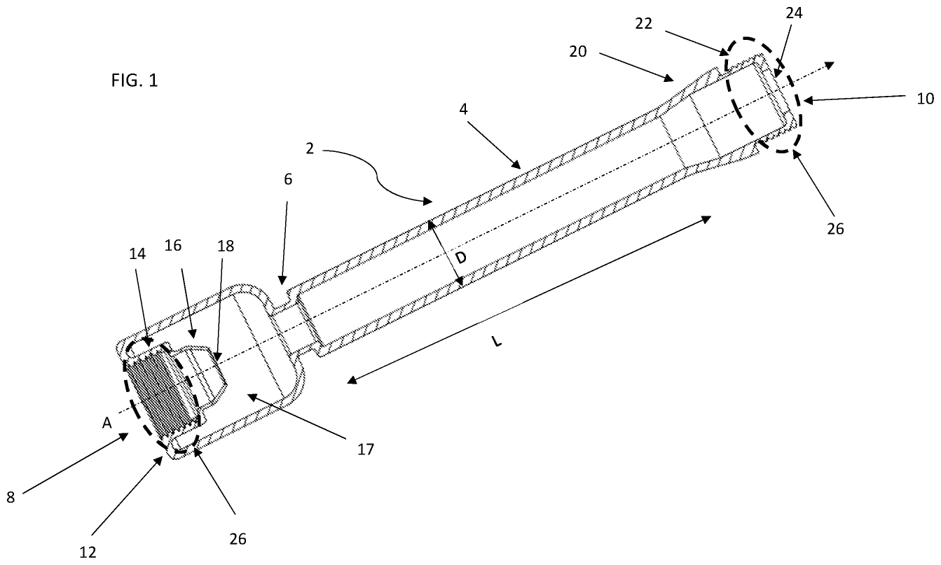

Referring to FIG. 1, a perspective diagram of one implementation of a universal anti-leak hose system 2 according to the principles of the present disclosure is shown. More specifically, an anti-leak hose system may comprise of a cylindrical body 4 having a length (L) and an outer diameter (D), an inlet end 8 and an outlet end 10. In some cases, the inlet end and the outlet end are reversible (e.g., both female or both male). In some cases the inlet end and the outlet end are different (e.g., one female and one male). In certain cases, the input end and the output end are universal, i.e., can be used as either a female or male end.

In one implementation, the inlet end 8 is a female end comprising from an outer end surface 12 of the inlet end and moving towards the body 4, an interior threaded section 14 and a angled section 16 protruding into the interior of a cavity 17 and terminating with an interior opening 18. In certain implementations, the cavity 17 of the female end is attached to the body 4 via a collar 6. In some implementations, the collar 6 has an outer diameter smaller than the outer diameter of the cavity. In some implementations, the outer diameter of the collar 6 is smaller than the outer diameter of the body. In certain implementations, the outlet end 10 is a male end comprising from the body 4 towards an exterior opening 24, a angled section 20 widening in a direction of the exterior opening and followed by an externally threaded section 22 terminating at the exterior opening 24.

In some implementations of the anti-leak hose system, a series of ridges 26 (here shown as threaded sections) are found at the far ends of the body at inlet and outlet ends, respectively and are configured to mate with an opposing fitting (i.e., a female end mates with a male end) in a liquid/gas system. In one example, the ridges 26 are located in an interior space within the interior of the hose system as in a female end. In another example, the ridges 26 are located on the exterior of the hose system as in a male end. The ridges 26 provide for expansion and contraction of the inlet and/or outlet ends of the hose system when the hose system is full of medium, or empty, respectively In certain implementations, ridges 26 (shown here within a dashed ellipse) could be contiguous like a thread or could be a plurality of smaller protrusions in series for used in a press fit application, or the like.

Still referring to FIG. 1, the body 4 can be of any length (L) or outer diameter (D) depending on the application. In some cases, the body is cylindrical. In some instances the body has a cross-sectional profile of a square, a hexagon, or some other shape. It is understood that depending on the application and the materials used, an inner diameter (or sidewall thickness) of the body may also vary. By way of example, if the application is in place of a conventional garden hose the outer diameter of the body may be ⅝″ or ¾″ and the length may be 25, 50, or 100 feet. Alternatively, if the subject of the present disclosure is to be used to stop a leak in a legacy system then the length of the body may only need to be a few inches long. In other applications, the body may be a few inches long and have an outer diameter of about ⅛″ when used in smaller systems (e.g., a water pick, or the like).

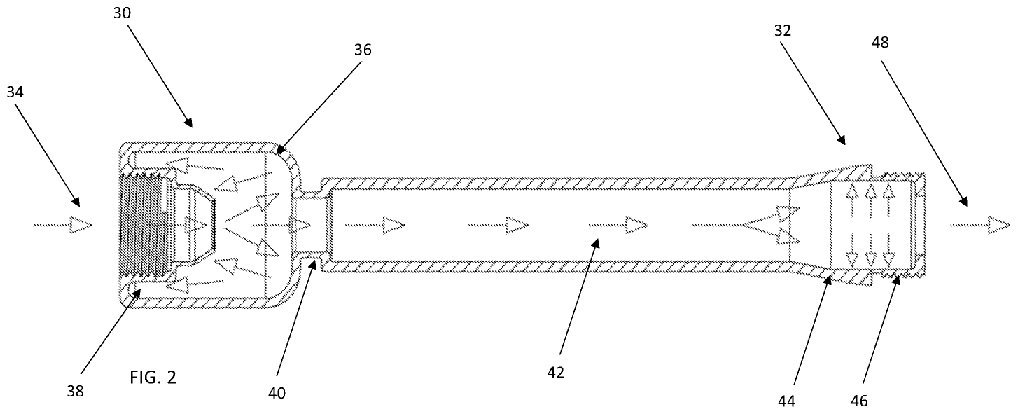

Referring to FIG. 2, a cross-sectional diagram showing flow of gas and/or liquid within one implementation of a universal anti-leak hose system according to the principles of the present disclosure is shown. More specifically, a series of arrows are used to show how liquid or gas flows within the anti-leak hose system having a female end 30 and a male end 32. Just for the sake of clarity, we will assume the liquid is water. First, water enters an inlet 34 and flows into the interior of the cavity of the hose system where some portion of the water encounters an inner wall of the cavity 36 and is directed back towards an interior space 38 in the interior of the cavity surrounding a threaded portion and another portion of the water is directed toward the portion of the hose system having a smaller inner diameter 40 and moves into the interior of the body 42. The water reaches the angled area 44 at the male end and the flow widens and creates pressure at the externally threaded section 46 to expand and exert additional pressure on a portion of a gas/liquid system (e.g., a spigot, a valve, an inlet, an outlet, a hose or tube end, and the like) surrounding or threaded onto the hose system and eventually exits the hose system 48.

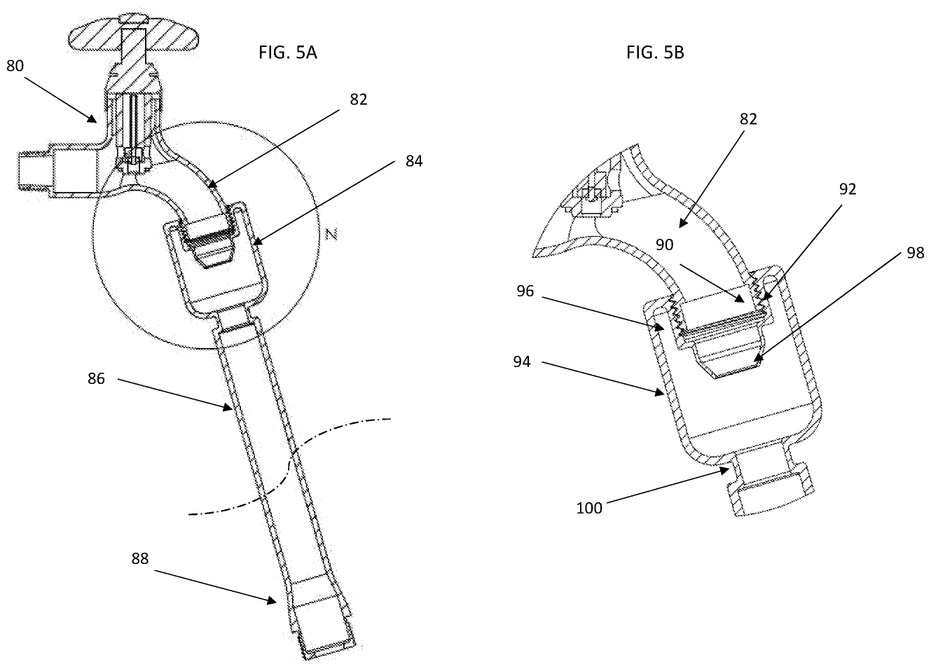

Still referring to FIG. 2, water that is directed back toward the inlet is also directed into an interior space 38 between the inlet threaded section and the sidewall of the cavity of the female end of the hose system. The water being directed into this confined interior space causes the interior space 38 to expand and exert additional pressure on a portion of a gas/liquid system (e.g., a spigot, a valve, a hose, a mated end, and the like) inserted or threaded into the hose system (See, e.g., FIG. 5A and FIG. 5B).

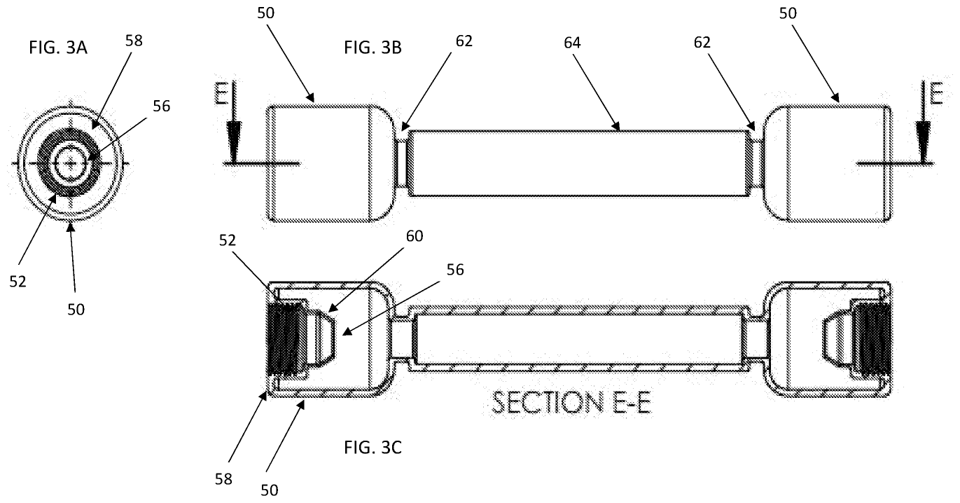

Referring to FIG. 3A-FIG. 3C, an end view, a perspective view, and a cross-sectional view, respectively, of one implementation of a universal anti-leak hose system according to the principles of the present disclosure is shown. More specifically, this implementation shows an end view on a female to female universal anti-leak hose system. In FIG. 3A, the outer most ring represents the outer wall of the cavity 50. An internally threaded portion 52 is configured to mate with a male connection in a gas/liquid system. The innermost ring in the figure represents the inner opening 56. An interior space 58 is shown in this and FIG. 3C. In FIG. 3B, a perspective view of the exterior of one implementation of a universal anti-leak hose system according to the principles of the present disclosure is shown. There, two cavities 50 are shown on either end representing one implementation of a female end and they are connected to either end of a body 64 via collars 62. In FIG. 3C, the components of the female end are visible and labeled on one end, namely, the outer wall of the cavity 50, an internally threaded portion 52 configured to mate with a male connection in a gas/liquid system, the interior space 58, and a angled section 60 terminating at the inner opening 56 having an inner diameter. The interior space 58 provides for expansion and contraction and is configured to expand when pressurized to further limit any potential for leaks.

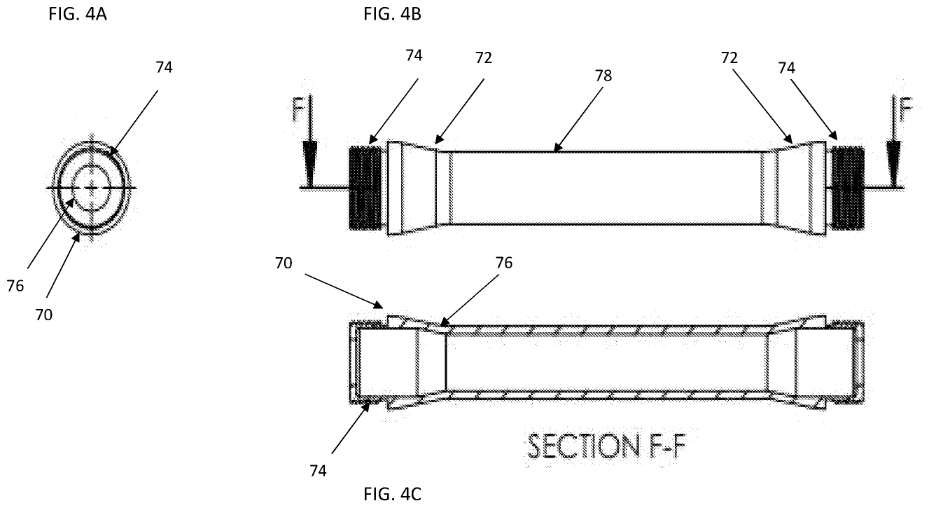

Referring to FIG. 4A-FIG. 4C, an end view, a perspective view, and a cross-sectional view, respectively, of one implementation of a universal anti-leak hose system according to the principles of the present disclosure is shown. More specifically, this implementation is a male to male implementation of the universal anti-leak hose system according to the principles of the present disclosure. In FIG. 4A, the outermost ring represents an exterior flange 70 located at the widest end of the angled section 72. The dark ring represents the externally threaded section 74 and the innermost ring 76 represents the narrow end of the angled section. In FIG. 4B, a male to male implementation of the universal anti-leak hose system according to the principles of the present disclosure is shown as having externally threaded sections 74, and angled sections 72 located on either end of the hose body 78. In FIG. 4C, the components of the male end are visible and labeled on one end, namely, the externally threaded portion 74 configured to mate with a female connection in a gas/liquid system, the outer flange 70 located at the wide end of the angled section and the narrow end of the angled section 76, where that narrow end has an inner diameter. The externally threaded portion is configured to expand when pressurized to further limit any potential for leaks.

Referring to FIG. 5A and FIG. 5B, cross-sectional diagrams of one implementation of a universal anti-leak hose system with a spigot inserted into an end according to the principles of the present disclosure are shown. FIG. 5B is the enlarged view of region N in FIG. 5A. More specifically, in FIG. 5A, a standard outdoor spigot 80 is shown having a portion 82 with a male end. This spigot having a male end is shown being inserted into a female end 84 of an anti-leak hose system. It is understood that the body 86 of the anti-leak hose system can be any length as demonstrated by the curved dashed line. As discussed previously, if this is a garden hose example, the body length might be 25′, 50′, 100′ or some other length to fit a particular application. At the opposing end of the anti-leak hose system there is a male end 88, but it is understood that various configuration are possible depending on the desired application. In FIG. 5B, the region where the male end of an existing system (e.g. spigot) interacts with the female end of an implementation of a universal anti-leak hose system of the present disclosure is shown enlarged to show more detail. More specifically, a gas/liquid system portion 82 with a male end configured with an externally threaded portion 90 is shown mating to the internally threaded portion 92 of the female end of an implementation of a universal anti-leak hose system of the present disclosure. The outer wall of the cavity 94 forms an interior space 96 that surrounds the internally threaded portion 92 of the universal anti-leak hose system and when pressurized exerts additional pressure on the mated connection to mitigate any leaks at the connection. The interior opening 98 at the narrow end of the angled section creates a system that when the medium (e.g., water) encounters the inner wall of the cavity at the narrow portion formed by the collar 100, creates the increase in pressure within the cavity, and particularly the interior space surrounding the internally threaded portion 92.

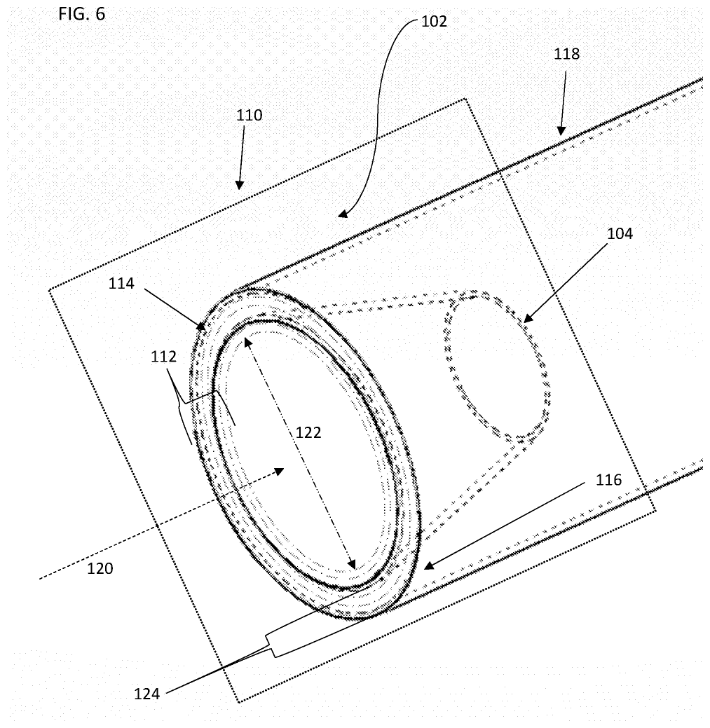

Referring to FIG. 6, an enlarged perspective view of another implementation of an end of a universal anti-leak hose system according to the principles of the present disclosure is shown. More specifically, this figure provides a perspective of an outer opening region 110 at an end of a universal anti-leak hose system 102. In certain implementations, a series of ridges 112 are present at the outer opening region. These ridges may be a series of solid concentric ridges or made up of a series of smaller spaced ridges similar to a dashed line (pictured). In certain implementations, the ridges are located “on” an exterior end portion 114 or “in” an interior end portion 116 of the outer opening. In certain implementations, the ridges extend toward the interior of the body 118 at an outer end portion of the angled portion and may be on the inside or outside of the angled portion. The number of ridges may be modified depending on the application. It is understood that the body 118 may be constructed of materials that are less flexible when compared to the materials used to construct the end portions of the universal anti-leak system as the ends are configured to fit in or over fittings and expand when pressurized to mitigate leaking while the body of the universal anti-leak hose system can withstand pressures and be robust. In some cases, the body may be reinforced.

In certain implementations, as a portion of a gas/liquid system (not shown) is pushed into the body 118 along a direction 120, an outward force 122 is exerted toward the walls of the angled section such that a pressure fit is formed between an inserted portion of a gas/liquid system (not shown) and the walls of the angled section and a space 124 is compressed. As shown in FIG. 2, once a medium is introduced into the hose system at a flow rate and the medium meets a resistance of the body of the hose system, turbulence is formed and creates areas of pressure exerted against ends of a portion of a gas/liquid system (e.g., a spigot, a valve, an inlet an outlet, a tube or hose end, or the like) to make a connection between it and the hose system tighter to mitigate leaking. Because the universal anti-leak hose system 102 has a angled design, various size portions of gas/liquid systems may be used effectively so long as the outer diameter of the portion of the gas/liquid system is larger than the interior opening 104 and smaller than the inlet or outlet end of the hose system depending on the orientation.

In certain implementations of the anti-leak hose systems of the present disclosure, the hose system and the inlet and outlet portions are integrally formed of one type of elastomeric material. In some cases the elastomeric material may be one or more of natural rubbers, styrene-butadiene block copolymers, polyisoprene, polybutadiene, ethylene propylene rubber, ethylene propylene diene rubber, silicone elastomers, fluoroelastomers, polyurethane elastomers, nitrile rubbers, or some other elastomeric material. In certain implementations, the side wall of the body will have a thickness that is designed to withstand pressures typical for the particular application. In some cases, the material will be robust against high or low temperature, acids, and other caustic media (i.e., gas and/or liquid). The length and pitch of the angled section (and therefore the difference in diameter of an outermost opening and an interior opening) may be of various sizes to adapt to different applications. Additionally, the angled section may have a thickness different from the sidewall of the body to provide for better resistance for insertion of a portion of a gas/liquid system into the system such that the inserted portion of a gas/liquid system is retained when no fluid or gas is percent. When gas or fluid is present, the outermost (end) portion of the inlet and/or outlet may expand and exert additional pressure against the inserted portion of a gas/liquid system to retain it in place and mitigate leaking.

In some implementations, the body of the universal anti-leak hose system has a length ranging from about 1 inch to about 1000 feet. In some implementations, the body of the universal anti-leak hose system has a length ranging from about 2 inches to about 750 feet. In some implementations, the body of the universal anti-leak hose system has a length ranging from about 3 inches to about 500 feet. In some implementations, the body of the universal anti-leak hose system has a length ranging from about 3 inches to about 200 feet. In some implementations, the body of the universal anti-leak hose system has a length ranging from about 3 inches to about 100 feet. In some implementations, the body of the universal anti-leak hose system has a length ranging from about 3 inches to about 75 feet. In some implementations, the body of the universal anti-leak hose system has a length ranging from about 3 inches to about 50 feet. In some implementations, the body of the universal anti-leak hose system has a length ranging from about 3 inches to about 25 feet. In some implementations, the body of the universal anti-leak hose system has a length ranging from about 3 inches to about 10 feet. In some implementations, the body of the universal anti-leak hose system has a length ranging from about 3 inches to about 5 feet. In some implementations, the body of the universal anti-leak hose system has a length ranging from about 3 inches to about 1 foot. In some implementations, the body of the universal anti-leak hose system has a length ranging from about 3 inches to about 10 inches.

In some implementations, the body of the universal anti-leak hose system has a length of about 1 inch, about 2 inches, about 3 inches, about 4 inches, about 5 inches, or about 6 inches. In some implementations, the body of the universal anti-leak hose system has a length of about 7 inches, about 8 inches, about 9 inches, about 10 inches, about 11 inches, or about 12 inches. In some implementations, the body of the universal anti-leak hose system has a length of about 1 foot, about 2 feet, about 3 feet, about 4 feet, about 5 feet, or about 6 feet. In some implementations, the body of the universal anti-leak hose system has a length of about 7 feet, about 8 feet, about 9 feet, about 10 feet, about 11 feet, or about 12 feet. In some implementations, the body of the universal anti-leak hose system has a length of about 10 feet, about 20 feet, about 30 feet, about 40 feet, about 50 feet, or about 60 feet. In some implementations, the body of the universal anti-leak hose system has a length of about 70 feet, about 80 feet, about 90 feet, about 100 feet, about 110 feet, or about 120 feet. In some implementations, the body of the universal anti-leak hose system has a length of about 100 feet, about 200 feet, about 300 feet, about 400 feet, about 500 feet, or about 600 feet. In some implementations, the body of the universal anti-leak hose system has a length of about 700 feet, about 800 feet, about 900 feet, or about 1000 feet.

In some implementations, the body of the universal anti-leak hose system has an outer diameter that ranges from of about ⅛ inch to about 30 inches. In some implementations, the body of the universal anti-leak hose system has an outer diameter that ranges from of about ½ inch to about 24 inches. In some implementations, the body of the universal anti-leak hose system has an outer diameter that ranges from of about ⅝ inch to about 18 inches. In some implementations, the body of the universal anti-leak hose system has an outer diameter that ranges from of about ¾ inch to about 12 inches. In some implementations, the body of the universal anti-leak hose system has an outer diameter that ranges from of about 1 inch to about 8 inches. In some implementations, the body of the universal anti-leak hose system has an outer diameter that ranges from of about 1 inch to about 6 inches. In some implementations, the body of the universal anti-leak hose system has an outer diameter that ranges from of about 1 inch to about 4 inches.

In some implementations, the body of the universal anti-leak hose system has an outer diameter of about ⅛ inch, about ¼ inch, about ⅜ inch, about ½ inch, about ⅝ inch, about ¾ inch, or about ⅞ inch. In some implementations, the body of the universal anti-leak hose system has an outer diameter of about 1 inch, about 2 inches, about 3 inches, about 4 inches, about 5 inches, about 6 inches, about 7 inches, or about 8 inches. In some implementations, the body of the universal anti-leak hose system has an outer diameter of about 9 inches, about 10 inches, about 11 inches, about 12 inches, about 13 inches, about 14 inches, about 15 inches, or about 16 inches. In some implementations, the body of the universal anti-leak hose system has an outer diameter of about 17 inches, about 18 inches, about 19 inches, about 20 inches, about 21 inches, about 22 inches, about 23 inches, or about 24 inches. In some implementations, the body of the universal anti-leak hose system has an outer diameter of about 25 inches, about 26 inches, about 27 inches, about 28 inches, about 29 inches, or about 30 inches.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the disclosure. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

While various implementations of the present disclosure have been described in detail, it is apparent that various modifications and alterations of those implementations will occur to and be readily apparent to those skilled in the art. However, it is to be expressly understood that such modifications and alterations are within the scope and spirit of the present disclosure, as set forth in the appended claims. Further, the disclosure(s) described herein is capable of other implementations and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the implementations of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A universal anti-leak hose system, comprising:
a hollow body having a length and an outer diameter;
an outer opening at a first end of the hollow body and an outer opening at a second end of the hollow body; and
at least one angled section extending inwardly into an interior of a cavity and terminating at an interior opening.

2. The system according to claim 1, wherein the at least one angled section is a pair of angled sections at the first end of the hollow body and the second end of the hollow body.

3. The system according to claim 1, wherein the hollow body is cylindrical.

4. The system according to claim 1, wherein the hollow body has at least one portion having a reduced inner diameter located between the first end of the hollow body and the second end of the hollow body.

5. The system according to claim 1, further comprising at least one internally threaded portion located within the cavity between the outer opening of the first end of the hollow body and the at least one angled section, and wherein an interior space is formed between an inner surface of the cavity and the internally threaded portion.

6. The system according to claim 5, wherein the hollow body, the outer opening at a first end of the hollow body, the cavity, the internally threaded portion; and the at least one angled section are integrally formed of an elastomeric material.

7. The system according to claim 6, wherein the elastomeric material is a rubber.

8. The system according to claim 6, wherein the elastomeric material is a silicone elastomer.

9. The system according to claim 1, further comprising an externally threaded portion located at the outer opening of the second end of the hollow body.

10. A universal anti-leak hose system, comprising:
a hollow body;
an outer opening at a first end of the hollow body and an outer opening at a second end of the hollow body;
at least one angled section extending outwardly from the hollow body to the outer opening of the first end of the hollow body; and
at least one externally threaded portion located at the outer opening of the first end of the hollow body.

11. The system according to claim 10, wherein the at least one angled section is a pair of angled sections at the first end of the hollow body and the second end of the hollow body.

12. The system according to claim 10, wherein the hollow body is cylindrical.

13. The system according to claim 10, wherein the hollow body has a portion having a reduced inner diameter located between the first end of the hollow body and the second end of the hollow body.

14. The system according to claim 10, wherein the hollow body, the externally threaded portion; and the at least one angled section are integrally formed of an elastomeric material.

15. The system according to claim 14, wherein the elastomeric material is a rubber.

16. The system according to claim 14, wherein the elastomeric material is a silicone elastomer.

17. The system according to claim 10, further comprising at least one internally threaded portion located between the outer opening of the second end of the hollow body and a angled section, within a cavity, and wherein an interior space is formed between an inner surface of the cavity and the internally threaded portion.

18. A universal anti-leak hose system, comprising:
a hollow cylindrical body;
an outer opening at a first end of the hollow cylindrical body;
at least one angled section extending inwardly from the outer opening into an interior of the hollow cylindrical body and terminating at an interior opening, the interior opening having a smaller diameter than a diameter of the outer opening;
an interior space being formed between an inner surface of a sidewall of the hollow cylindrical body and the angled section; and
one or more ridges located at a region comprising the outer opening.

19. The system according to claim 18, wherein the hollow cylindrical body has a portion having a reduced inner diameter located between the first end of the hollow cylindrical body and a second end of the hollow cylindrical body.

20. The system according to claim 18, wherein the one or more ridges and the sidewall of the hollow cylindrical body are formed of an elastomeric material integrally with the hollow cylindrical body, the outer opening at a first end of the hollow cylindrical body and the at least one angled section.
